(19) United States
(12) Patent Application Publication
(10) Pub. No.: US 2007/0032902 A1
(43) Pub. Date: Feb. 8, 2007

(54) Method and apparatus for transporting items

(75) Inventors: John William Bridges, Pflugerville, TX (US); Jill C. Gravett, Austin, TX (US); James Quirke, Westbury (IE)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/196,975

(22) Filed: Aug. 4, 2005

(51) Int. Cl. G06F 7/00

(52) U.S. Cl. 700/213

(57) ABSTRACT

An item transporting apparatus includes a transporting container including a container entrance, and a container access channel defined by the transporting container and located adjacent the container entrance. A plurality of items may be transported in the container positioned in a manner which occupies a minimal volume, and the plurality of items may be removed from the transporting container by using a vacuum lifting device which accesses the items through the container access channel.

### BACKGROUND

The present disclosure relates generally to information handling systems, and more particularly to a method and apparatus for transporting items such as, for example, information handling systems.

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The transporting of items such as, for example, information handling systems, raises a number of issues. To decrease transportation costs, the volume of the items in transport and the transportation container should be kept to a minimum to increase the number of transportation containers per transportation vehicle such as, for example, trailer or sea container. To decrease labor costs it is desirable to automate the processes involved with transporting of the items.

Conventionally, the transportation of information handling systems may be automated by using a vacuum lifting device to remove the information handling systems from a transportation container. To accomplish this automation, a plurality of information handling systems are positioned in the transportation container in a horizontal orientation and stacked on top of each other, which exposes a flat surface of the information handling system on the top of the stack to the entrance of the transportation container. The information handling systems may then be removed from the transportation container by coupling the vacuum lifting device to the flat surface of an information handling system and lifting it out of the transportation container. However, the horizontal stacking of the plurality of information handling systems can result in damage to the information handling systems positioned at the bottom of the stack due to the weight of the information handling systems positioned above them.

The solution to the problems related to information handling system damage due to weight stackup is to position the plurality of information handling systems in the transportation container in a vertical orientation and side by side. This ensures that none of the information handling systems will have to support the weight of other information handling systems, and it further allows the provision of a transportation container which has a minimal volume, which reduces transportation costs. However, with the information handling systems positioned in a vertical orientation and side by side in the transportation container, there is no access to a flat surface of sufficient area on an information handling system to allow the use of a vacuum lifting device to automate the process of removing the information handling systems from the transportation container.

Accordingly, it would be desirable to provide a method and apparatus for transporting items absent the disadvantages found in the prior methods discussed above.

### SUMMARY

According to one embodiment, an item transporting apparatus is provided which includes a transporting container having a container entrance, and a container access channel defined be the transporting container and located adjacent the container entrance.

### BRIEF DESCRIPTION OF THE DRAWINGS

FIG. 1 is a schematic view illustrating an embodiment of an information handling system.

FIG. 2 is a perspective view illustrating an embodiment of a transporting container.

FIG. 3 is a perspective view illustrating an embodiment of a packing member used with the transporting container of FIG. 2.

FIG. 4a is a top perspective view illustrating an embodiment of a container lid used with the transporting container of FIG. 2 and the packing member of FIG. 3.

FIG. 4b is a bottom perspective view illustrating an embodiment of the container lid of FIG. 4a.

FIG. 5 is a perspective view illustrating an embodiment of an item used with the transporting container of FIG. 2, the packing member of FIG. 3, and the container lid of FIG. 4a.

FIG. 6a is a side view illustrating an embodiment of a vacuum lifting device used with the transporting container of FIG. 2, the packing member of FIG. 3, the container lid of FIG. 4a, and the item of FIG. 5.

FIG. 6b is a front view illustrating an embodiment of the vacuum lifting device of FIG. 6a.

FIG. 7a is a flow chart illustrating an embodiment of a method for transporting items.

FIG. 7b is a perspective view illustrating an embodiment of the packing member of FIG. 3 being positioned in the transporting container of FIG. 2.

FIG. 7c is a perspective view illustrating an embodiment of the packing member of FIG. 3 positioned in the transporting container of FIG. 2.

FIG. 7d is a perspective view illustrating an embodiment of the item of FIG. 5 being positioned in the packing member and transporting container of FIG. 7c.

FIG. 7e is a perspective view illustrating an embodiment of the item of FIG. 5 positioned in the packing member and transporting container of FIG. 7c.

FIG. 7f is a perspective view illustrating an embodiment of a plurality of the items of FIG. 5 positioned in the packing member and transporting container of FIG. 7c.

FIG. 7g is a perspective view illustrating an embodiment of the container lid of FIG. 4 being positioned on the plurality of items, the packing member, and transporting container of FIG. 7f.

FIG. 7h is a perspective view illustrating an embodiment of the container lid of FIG. 4 positioned on the plurality of items, the packing member, and transporting container of FIG. 7f.

FIG. 7i is a perspective view illustrating an embodiment of the vacuum lifting device of FIG. 6 being coupled to an item in the packing member and transporting container of FIG. 7f.

FIG. 7j is a perspective view illustrating an embodiment of the vacuum lifting device of FIG. 6 coupled to an item in the packing member and transporting container of FIG. 7f.

FIG. 7k is a perspective view illustrating an embodiment of the vacuum lifting device of FIG. 6 removing an item from the packing member and transporting container of FIG. 7f.

FIG. 7l is a perspective view illustrating an embodiment of the vacuum lifting device of FIG. 6 being coupled to an item in the packing member and transporting container of FIG. 7k.

FIG. 7m is a perspective view illustrating an embodiment of the vacuum lifting device of FIG. 6 removing an item from the packing member and transporting container of FIG. 7k.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

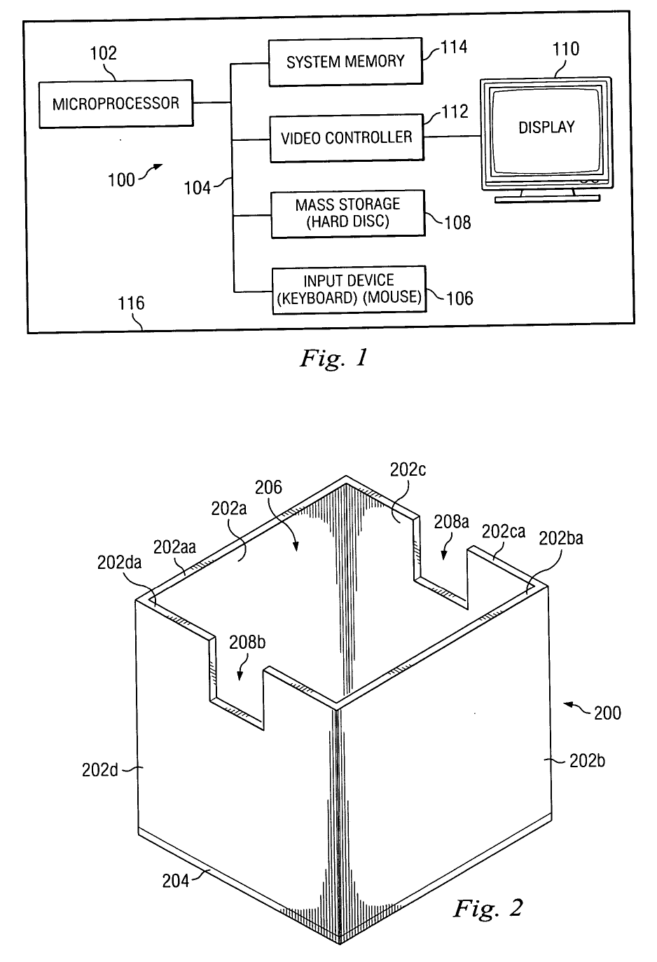

In one embodiment, information handling system 100, FIG. 1, includes a microprocessor 102, which is connected to a bus 104. Bus 104 serves as a connection between microprocessor 102 and other components of computer system 100. An input device 106 is coupled to microprocessor 102 to provide input to microprocessor 102. Examples of input devices include keyboards, touchscreens, and pointing devices such as mouses, trackballs and trackpads. Programs and data are stored on a mass storage device 108, which is coupled to microprocessor 102. Mass storage devices include such devices as hard disks, optical disks, magneto-optical drives, floppy drives and the like. Computer system 100 further includes a display 110, which is coupled to microprocessor 102 by a video controller 112. A system memory 114 is coupled to microprocessor 102 to provide the microprocessor with fast storage to facilitate execution of computer programs by microprocessor 102. In an embodiment, a chassis 116 houses some or all of the components of information handling system 100. It should be understood that other busses and intermediate circuits can be deployed between the components described above and microprocessor 102 to facilitate interconnection between the components and the microprocessor.

Referring now to FIG. 2, a transporting container 200 is illustrated. The transporting container 200 includes a plurality of substantially parallel and spaced apart side walls 202a and 202b each including a respective wall edge 202aa and 202ba on a distal portion of the side walls 202a and 202b, respectively. A plurality of substantially parallel and spaced apart side walls 202c and 202d extend between and are located in a substantially perpendicular orientation to the side walls 202a and 202b. The side walls 202c and 202d each include a respective wall edge 202ca and 202da on a distal portion of the side walls 202c and 202d, respectively. A bottom wall 204 extends between the side walls 202a, 202b, 202c, and 202d and is located opposite the walls edges 202aa, 202ba, 202ca, and 202da. In an embodiment, the side walls 202a, 202b, 202c, and 202d define a container volume 206 between them and the wall edges 202aa, 202ba, 202ca, and 202da form a container entrance adjacent the container volume 206. The side wall 202c defines a container access channel 208a which is substantially centrally located adjacent the wall edge 202ca on side wall 202c. The side wall 202d defines a container access channel 208b which is substantially centrally located adjacent the wall edge 202da on side wall 202d. In an embodiment, the container access channels 208a and 208b are dimensioned such that they will allow a conventional vacuum lifting device such as, for example, a vacuum lifting device available from Vacutrade USA, 1406 A North Market St., P.O. Box 405, Monticello, Ill., 61856, to enter the container volume 206 through either of the container access channels 208a and 208b. In an embodiment, the transporting container 200 is fabricated from a corrugated material such as, for example, cardboard or plastic.

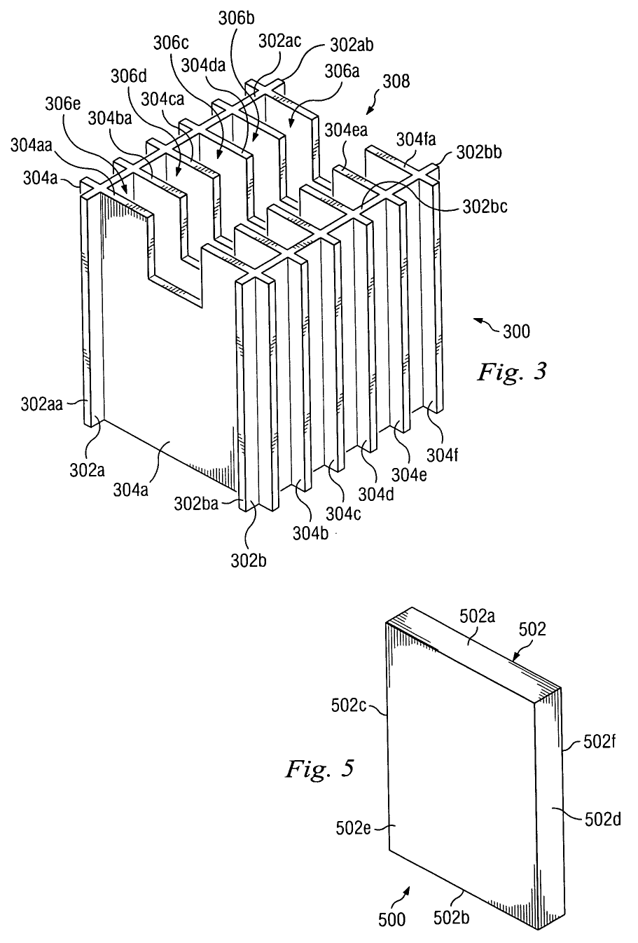

Referring now to FIG. 3, a packing member 300 is illustrated. Packing member 300 includes a pair of substantially perpendicular and spaced apart support walls 302a and 302b, the support wall 302a including a front edge 302aa, a rear edge 302ab located opposite the front edge 302aa, and a top edge 302ac extending between the front edge 302aa and the rear edge 302ab; and the support wall 302b including a front edge 302ba, a rear edge 302bb located opposite the front edge 302ba, and a top edge 302bc extending between the front edge 302ba and the rear edge 302bb.

A partition wall 304a extends between and is located in a substantially perpendicular orientation to the support walls 302a and 302b and includes a top edge 304aa adjacent the top edges 302ac and 302bc. A partition wall 304b extends between and is located in a substantially perpendicular orientation to the support walls 302a and 302b, substantially parallel to and spaced apart from partition wall 304a, and includes a top edge 304ba adjacent the top edges 302ac and 302bc. A partition wall 304c extends between and is located in a substantially perpendicular orientation to the support walls 302a and 302b, substantially parallel to and spaced apart from partition wall 304b, and includes a top edge 304ca adjacent the top edges 302ac and 302bc. A partition wall 304d extends between and is located in a substantially perpendicular orientation to the support walls 302a and 302b, substantially parallel to and spaced apart from partition wall 304c, and includes a top edge 304da adjacent the top edges 302ac and 302bc. A partition wall 304e extends between and is located in a substantially perpendicular orientation to the support walls 302a and 302b, substantially parallel to and spaced apart from partition wall 304d, and includes a top edge 304ea adjacent the top edges 302ac and 302bc. A partition wall 304f extends between and is located in a substantially perpendicular orientation to the support walls 302a and 302b, substantially parallel to and spaced apart from partition wall 304e, and includes a top edge 304fa adjacent the top edges 302ac and 302bc.

An item slot 306a is defined between the support walls 302a and 302b. The partition walls 302f and 302e and the top edges 302ac, 302bc, 304fa and 304ea form a slot entrance for item slot 306a. An item slot 306b is defined between the support walls 302a and 302b. The partition walls 302e and 302d and the top edges 302ac, 302bc, 304ea and 304da form a slot entrance for item slot 306b. An item slot 306c is defined between the support walls 302a and 302b. The partition walls 302d and 302c and the top edges 302ac, 302bc, 304da and 304ca form a slot entrance for item slot 306c. An item slot 306d is defined between the support walls 302a and 302b. The partition walls 302c and 302b and the top edges 302ac, 302bc, 304ca and 304ba form a slot entrance for item slot 306d. An item slot 306e is defined between the support walls 302a and 302b. The partition walls 302b and 302a and the top edges 302ac, 302bc, 304ba and 304aa form a slot entrance for item slot 306e. The partition walls 304a, 304b, 304c, 304d, 304e, and 304f define a packing member access channel 308 which is substantially centrally located adjacent the top edges 304aa, 304ba, 304ca, 304da, 304ea, and 304fa. In an embodiment, the packing member access channel 308 is dimensioned such that it will allow a conventional vacuum lifting device such as, for example, a vacuum lifting device available from Vacutrade USA, 1406 A North Market St., P.O. Box 405, Monticello, Ill., 61856, to enter the item slots 306a, 306b, 306c, 306d, and 306e, through the packing member access channel 308. In an embodiment, the packing member 300 is fabricated from a corrugated material such as, for example, cardboard or plastic. In an embodiment, the packing member 300 includes bottom support members (not shown) in each of the item slots 306a, 306b, 306c, 306d, and 306e in order to support items positioned in the packing member 300.

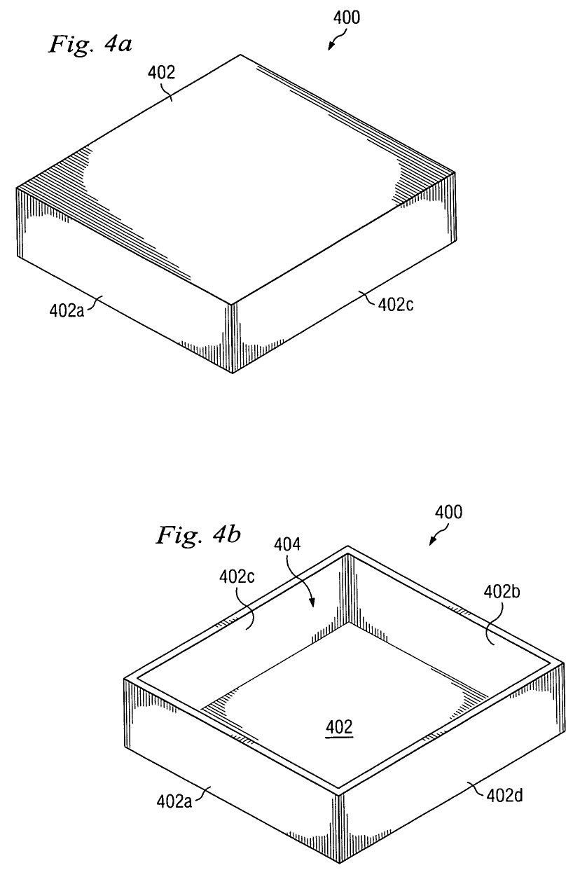

Referring now to FIGS. 4a and 4b, a container lid 400 is illustrated. Container lid 400 includes a base 402. A pair of substantially parallel and spaced apart side walls 402a and 402b extend from opposite sides of the base 402. A pair of substantially parallel and spaced apart side walls 402c and 402d extend from opposite sides of the base 402 and between the side walls 402a and 402b in a substantially perpendicular orientation relative to the side walls 402a and 402b. The base 402 and the side walls 402a, 402b, 402c, and 402d define a container lid volume 404 between them. In an embodiment, the container lid 400 is fabricated from a corrugated material such as, for example, cardboard or plastic.

Referring now to FIG. 5, an item 500 is illustrated. Item 500 includes a base 502 having a top surface 502a, a bottom surface 502b located opposite the top surface 502a, a pair of small opposing side surfaces 502c and 502d which extend between the top surface 502a and the bottom surface 502b, and a pair of large opposing side surfaces 502e and 502f which extend between the top surface 502a, the bottom surface 502b, and the pair of small side surfaces 502c and 502d. In an embodiment, at least one of the large opposing side surfaces 502e or 502f are dimensioned such that they will allow a conventional vacuum lifting device such as, for example, a vacuum lifting device available from Vacutrade USA, 1406 A North Market St., P.O. Box 405, Monticello, Ill., 61856, to couple to item 500. In an embodiment, the item 500 is an information handling system such as, for example, the information handling system 100 described above with reference to FIG. 1.

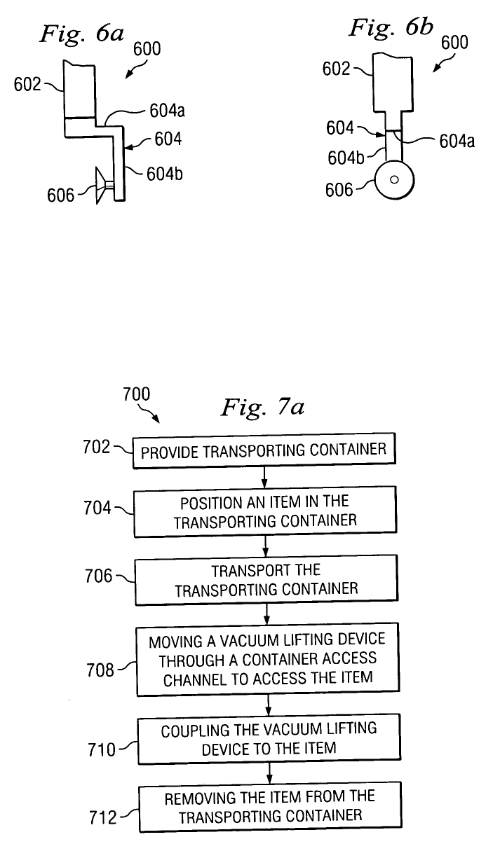

Referring now to FIGS. 6a and 6b, a vacuum lifting device 600 is illustrated. Vacuum lifting device 600 includes an arm 602 which is coupled to a conventional lifting mechanism (not shown) known in the art. A vacuum attachment 604 is coupled to the arm 602 and includes a perpendicular member 604a which extends in a substantially perpendicular orientation from the arm 602. A beam 604b extends in a substantially perpendicular orientation from the from the perpendicular member 604a and in a substantially parallel orientation relative to the arm 602. A vacuum member 606 is coupled to the beam 604b and is operable to couple to items such as, for example, the item 500, by engaging the item with the vacuum member 606 and creating a suction between the vacuum member 606 and the item. In an embodiment, the vacuum lifting device 600 is a conventional vacuum lifting device such as, for example, a vacuum lifting device available from Vacutrade USA, 1406 A North Market St., P.O. Box 405, Monticello, Ill., 61856.

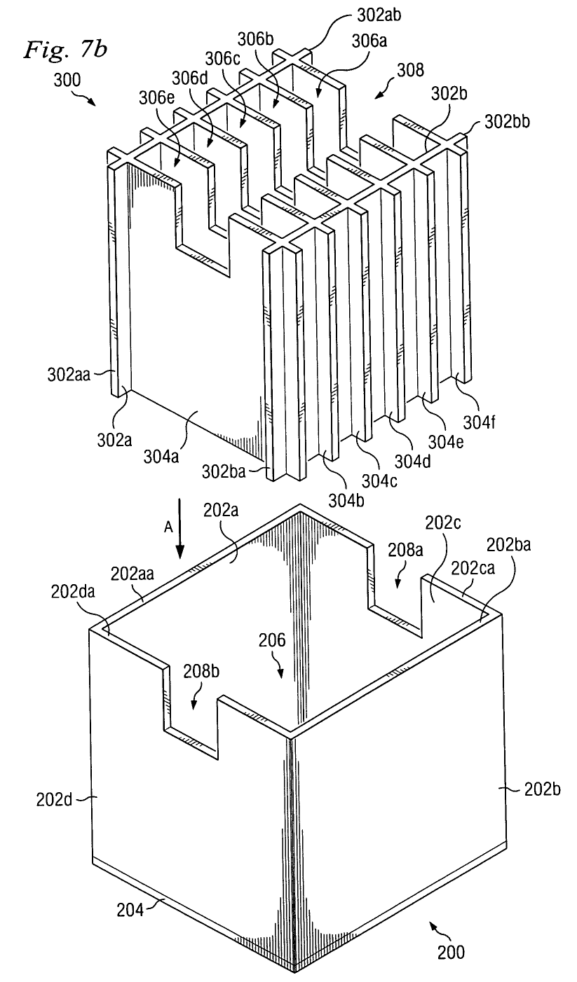

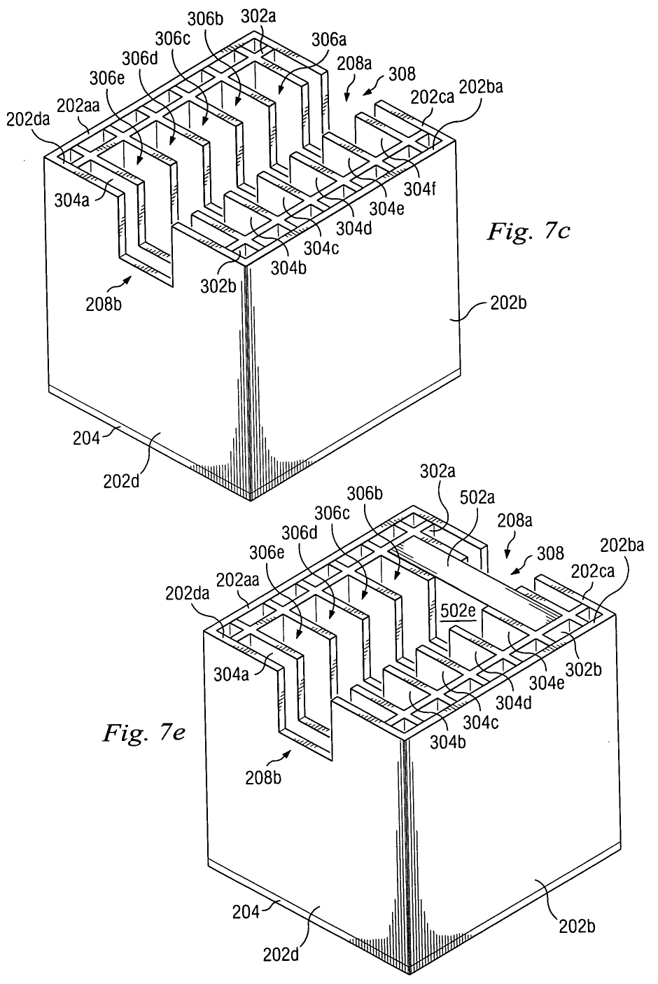

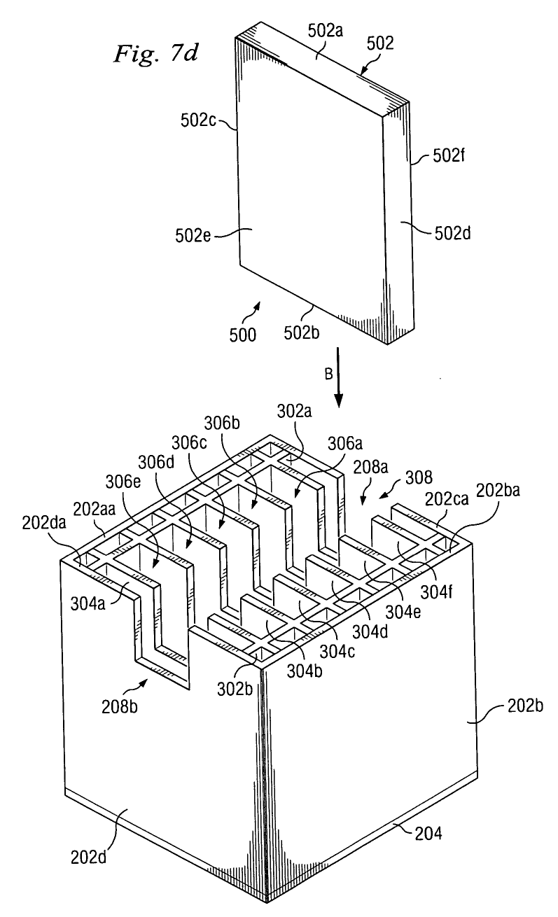

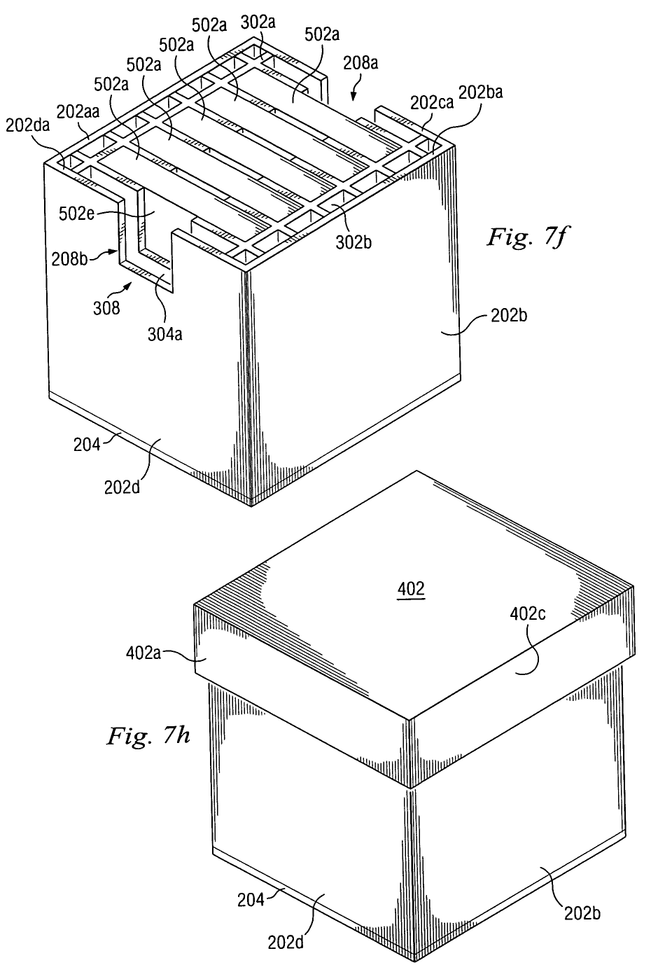

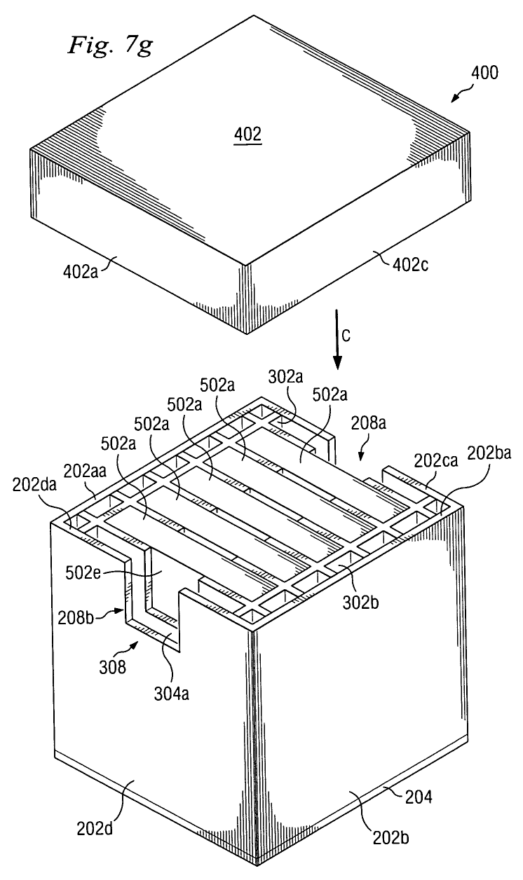

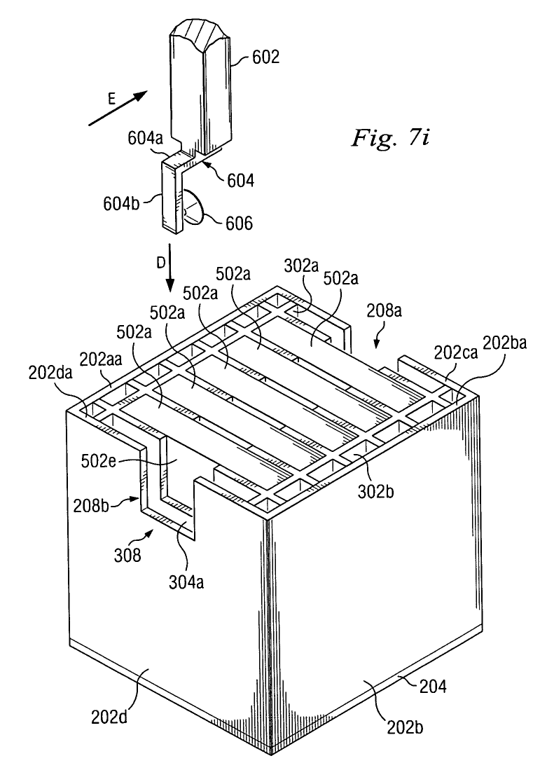

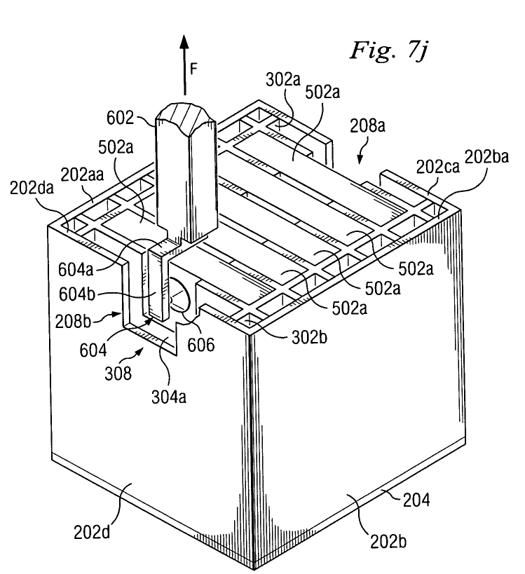

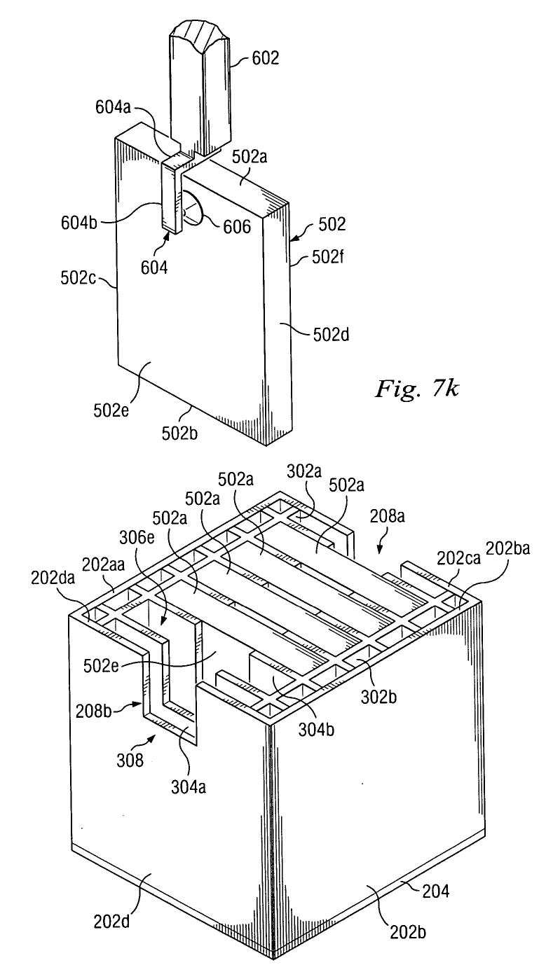

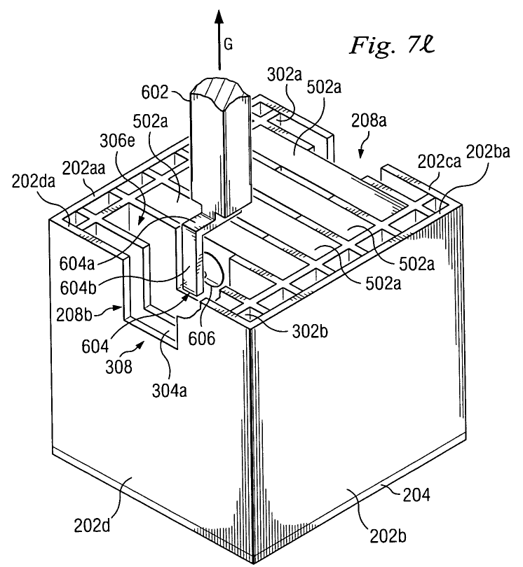

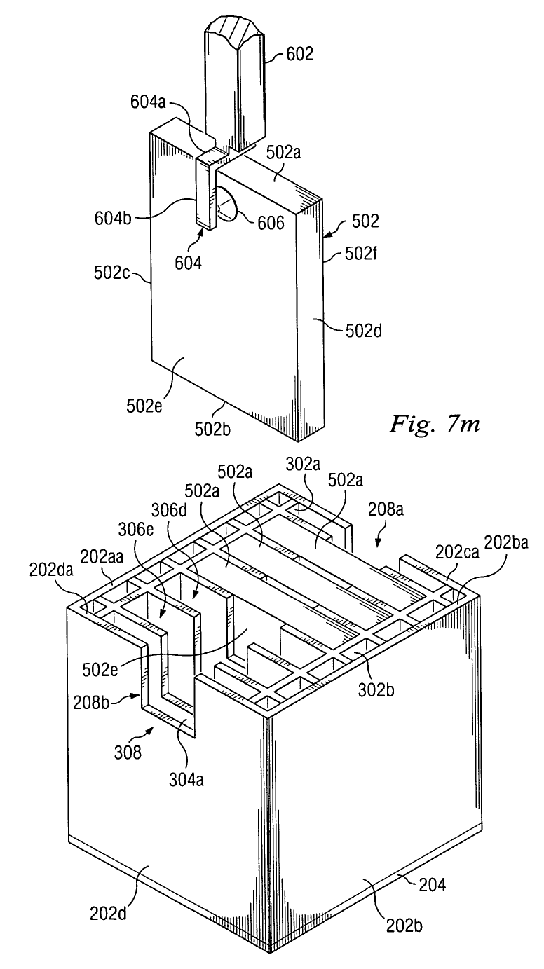

Referring now to FIGS. 2, 3, 7a, 7b, and 7c, a method 700 for transporting items is illustrated. The method 700 begins at step 702 where the transporting container 200 is provided. In an embodiment, the packing member 300 is positioned adjacent the transporting container 200 such that support wall 302a on packing member 300 is adjacent side wall 202a on transporting container 200, support wall 302b on packing member 300 is adjacent side wall 202b on transporting container 200, partition wall 304a on packing member 300 is adjacent side wall 202d on transporting container 200, and partition wall 304f on packing member 300 is adjacent side wall 202c on transporting container 200 as illustrated in FIG. 7b. The packing member 300 is then moved in a direction A such that the packing member 300 enters the container volume 206 and the front edges 302aa and 302ba of support walls 302a and 302b, respectively, engage the side wall 202d on transporting container 200; the rear edges 302ab and 302bb of support walls 302a and 302b, respectively, engage the side wall 202c on transporting container 200; and the opposing sides of the partition walls 302a, 302b, 302c, 302d, 302e, and 302f engage the opposing side walls 202a and 202b, as illustrated in FIG. 7c. In an embodiment, with the packing member 300 positioned in the transporting container 200, the packing member access channel 308 is substantially aligned with the container access channels 208a and 208b, providing a channel which runs through the transporting container 200 and packing member 300, as illustrated in FIG. 7c.

Referring now to FIGS. 2, 3, 7a, 7d, 7e, and 7f, the method 700 proceeds to step 704 where the item 500 is positioned in the transporting container 200. The item 500 is positioned above the transporting container 200 such that the bottom surface 502b on item 500 is adjacent the item slot 306a defined by packing member 300, with small side surfaces 502c and 502d on item 500 adjacent support walls 302a and 302b, respectively, on packing member 300, and large side surfaces 502e and 502f on item 500 adjacent partition walls 304e and 304f, respectively, on packing member 300, as illustrated in FIG. 7d. The item 500 is then moved in a direction B such that the item 500 enters the item slot 306a with small side surfaces 502c and 502d on item 500 engaging the support walls 302a and 302b, respectively, on packing member 300, and the large side surfaces 502e and 502f on item 500 engaging partition walls 304e and 304f, respectively, on packing member 300, as illustrated in FIG. 7e. A plurality of items 500 may be positioned in the transporting container 200 in substantially the same manner as described above by positioning the items 500 in the item slots 306b, 306c, 306d, and 306e, as illustrated in FIG. 7f. Positioning the plurality of items 500 in the transporting container 200 in the orientation shown in FIG. 7f allows the transporting container 200 to receive a maximum number of items 500 in the container volume 206 while taking up a minimum amount of volume. In an embodiment, the plurality of items 500 are positioned in the transporting container 200 in a substantially vertical orientation, as illustrated in FIG. 7f.

Referring now to FIGS. 2, 4a, 4b, 7a, 7g, and 7h, the method 700 then proceeds to step 706 where the transporting container 200 is transported. The container lid 400 is positioned adjacent the transporting container 200 such that the container lid volume 404 is adjacent the transporting container 200, with the side wall 402a on container lid 400 adjacent the side wall 202d on transporting container 200; the side wall 402b on container lid 400 adjacent the side wall 202c on transporting container 200; the side wall 402c on container lid 400 adjacent the side wall 202a on transporting container 200; and the side wall 402d on container lid 400 adjacent the side wall 202b on transporting container 200, as illustrated in FIG. 7g. The container lid 400 is then moved in a direction C such that the transporting container 200 enters the container lid volume 404, with the side wall 402a on container lid 400 engaging the side wall 202d on transporting container 200; the side wall 402b on container lid 400 engaging the side wall 202c on transporting container 200; the side wall 402c on container lid 400 engaging the side wall 202a on transporting container 200; and the side wall 402d on container lid 400 engaging the side wall 202b on transporting container 200, as illustrated in FIG. 7h. In an embodiment, the side walls 402a, 402b, 402c, and 402d on the container lid 400 extend a sufficient distance down the side of the transporting container 200 to increase the strength of the transporting container 200. In an embodiment, a sufficient distance for the side walls 402a, 402b, 402c, and 402d on the container lid 400 to extend down the side of the transporting container 200 includes a distance which allows the side walls 402a and 402b to extend past the container access channels 208a and 208b on transporting container 200, as illustrated in FIG. 7h. The transporting container 200 may then be transported using methods known in the art. In an embodiment, the container lid 400 increases the stacking strength of the transporting container 200, allowing a plurality of transporting containers 200 to be stacked on top of each other.

Referring now to FIGS. 3, 7a, 7i, and 7j, the method 700 proceeds to step 708 where the vacuum lifting device 600 is moved through the container access channel 208b to access the item 500. The container lid 400 may be removed by from the transporting container 200 in the reverse of the method by which it was coupled to the transportation container 200 in step 706, illustrated in FIGS. 7g and 7h. The vacuum lifting device 600 is then positioned adjacent the transporting container 200 such that the vacuum member 606 on vacuum lifting device 600 is adjacent the side wall 202d on transporting container 200, as illustrated in FIG. 7i. The vacuum lifting device 600 is then moved in a direction D such that the vacuum member 606 on vacuum lifting device 600 is adjacent the container access channel 208b on transporting container 200 and the packing member access channel 308 on packing member 300. The vacuum lifting member 606 is then moved in a direction E through the container access channel 208b on transporting container 200 and the packing member access channel 308 on packing member 300 until the vacuum member 606 engages the large side surface 502e of item 500 in item slot 306e, as illustrated in FIG. 7j.

Referring now to FIGS. 3, 7a, 7j, and 7k, the method 700 then proceeds to step 710 where the vacuum lifting device 600 is coupled to the item 500 in item slot 306e. In an embodiment, the vacuum member 606 may couple the vacuum lifting device 600 to the item 500 by creating a suction between the vacuum member 606 and the large side surface 502e of item 500. The method 700 then proceeds to step 712 where the item 500 is removed from the transporting container 200. The vacuum lifting apparatus 600 is moved in a direction F and the item 500 is removed from item slot 306e, as illustrated in FIG. 7k. The vacuum lifting device 600 may then be coupled to the item 500 positioned in item slot 306d, as illustrated in FIG. 7l, and removed from the item slot 306d, as illustrated in FIG. 7m, in substantially the same manner as described above for removing the item 500 from item slot 306e. The remainder of the items 500 in item slots 306a, 306b, and 306c may also be removed in substantially the same manner. Thus, a method and apparatus are provided which allow a plurality of items 500 to be transported using a minimum amount of volume, while allowing the removal of the items from the transporting container 200 to be automated. In an embodiment, the vacuum lifting device 600 may also be used to position the items 500 in the transporting container 200.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An item transporting apparatus comprising:
a transporting container having a container entrance; and
a container access channel defined by the transporting container and located adjacent the container entrance.

2. The apparatus of claim 1 wherein the transporting container is fabricated from a corrugated material.

3. The apparatus of claim 1 wherein the container access channel includes dimensions sufficient to allow a conventional vacuum lifting device to enter the transporting container through the container access channel.

4. The apparatus of claim 1 further comprising:
a packing member positioned in the transporting container;
at least one item slot defined by the packing member and including a slot entrance; and
a packing member access channel defined by the packing member and located adjacent the slot entrance.

5. The apparatus of claim 4 wherein the packing member is fabricated from a corrugated material.

6. The apparatus of claim 4 wherein the packing member access channel is substantially aligned with the container access channel.

7. The apparatus of claim 4 wherein the packing member access channel includes dimensions sufficient to allow a conventional vacuum lifting device to enter the at least one item slot through the packing member access channel.

8. The apparatus of claim 1 further comprising:
a container lid coupled to the transporting container.

9. The apparatus of claim 8 wherein the container lid increases the strength of the transporting container.

10. An item transporting apparatus comprising:
a transporting container having a container entrance;
a container access channel defined by the transporting container and located adjacent the container entrance;
a packing member positioned in the transporting container;
at least one item slot defined by the packing member and including a slot entrance;
a packing member access channel defined by the packing member and located adjacent the slot entrance; and
an item positioned in the at least one item slot.

11. The apparatus of claim 10 wherein the transporting container is fabricated from a corrugated material.

12. The apparatus of claim 10 wherein the packing member is fabricated from a corrugated material.

13. The apparatus of claim 10 wherein the container access channel includes dimensions sufficient to allow a conventional vacuum lifting device to enter the transporting container through the container access channel.

14. The apparatus of claim 10 wherein the packing member access channel includes dimensions sufficient to allow a conventional vacuum lifting device to enter the at least one item slot through the packing member access channel.

15. The apparatus of claim 10 wherein the packing member access channel is substantially aligned with the container access channel.

16. The apparatus of claim 10 further comprising:
a container lid coupled to the transportation container.

17. The apparatus of claim 16 wherein the container lid increases the strength of the transportation container.

18. The apparatus of claim 10 wherein the item is an information handling system.

19. The apparatus of claim 10 wherein the item is positioned in the item slot in a substantially vertical orientation.

20. A method for transporting items comprising:
providing a transporting container having a container entrance and defining a container access channel located adjacent the container entrance;
moving a vacuum lifting device through the container access channel to access an item positioned in the transporting container;
coupling the vacuum lifting device to the item; and
removing the item from the transporting container.

21. The method of claim 19 further comprising;
positioning an item in the transporting container; and
transporting the transporting container.

22. A system for transporting and unpacking items from a container comprising:
a container including a plurality of side by side slots separated by partitions;
an access channel formed in the partitions;
an item in each slot, a portion of the item being exposed in the access channel; and
a lifting device movable through the channel into lifting engagement with each item, whereby each item is removed from its respective slot.

23. A system for transporting and unpacking items from a container comprising:
a container including a plurality of side by side slots separated by partitions;
channel means formed in the partitions for exposing a portion of any items being stored in the slots; and
lifting means movable through the channel for lifting engagement with an exposed portion of each item.
